(19) United States
(12) Patent Application Publication
(10) Pub. No.: US 2005/0174228 A1
(43) Pub. Date: Aug. 11, 2005

(54) Front braking indicator light

(76) Inventor: Yong-Yu Lin, Gangshan Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/822,744

(22) Filed: Apr. 13, 2004

(30) Foreign Application Priority Data
Feb. 25, 2004 (CN) 200420043101.9
Feb. 6, 2004 (TW) 09320053860

(51) Int. Cl. B60Q 1/50

(52) U.S. Cl. 340/467; 340/479

(57) ABSTRACT

The present invention provides a front braking indicator light, which is mounted on front side of a car or a motorcycle, meanwhile is connected to the original control unit of the vehicle, so that when the driver is pressing down the brake to slow down the vehicle, the illuminator and the original braking indicator light are lighted in the same time, thereby not only indicating the running state of the vehicle, but also reminding the vehicles and pedestrians on the road to pay attention so as to avoid both sides misjudging to occur accident.

### BACKGROUND OF THE INVENTION

1. Field of the Invention

The present invention relates to an alarm device, and more particularly to a front braking indicator light, thereby reminding the vehicles and pedestrians in front of the car for avoiding them misjudging to occur accidents

2. Description of the Related Art

In general, a vehicle running at high speed indicates its running state to the back side vehicles for enhanced reminding effect, by only installing a braking indicator light at a proper position on the rear portion of the vehicle, thereby reminding the drivers in the back avoiding running upon.

So, during running, although the drivers in the back side vehicles can find the braking state of the front vehicle through the rear braking indicator light so as to control braking in a proper time, but if the front vehicle is over-passing or turning and so on, the driver can not find the back side vehicle's braking state, because the front side of the back side vehicle is not installed any braking indicator device, just only depending on the driver in the back side vehicle knowing a little bit of braking state of the front vehicle, often in high-speed running it easily occurs misjudge of the both sides to bring about accident, so it is a matter of common occurrence, and really need to be innovated, when the vehicle is turning, not even the pedestrians can find the running state of the vehicle, so that they just accord to the their experiment to judge whether the vehicle is going to be braked to slow down for pedestrians passing, besides occurring to make people injure or die in accidents, the both sides often slow down the speed as in the judge term to affect the traffic, so this situation should be improved.

For overcoming above-mentioned shortcomings, an innovated braking indicator light was came out, as shown in FIG. 1 and FIG. 2, in which the vehicle 1 is taken a car as an example. Said vehicle 1 includes a body 11, a front braking indicator light 2 set on the body 11, and wheels 12 moving the body 11; wherein, said front braking indicator light 2 is comprised of a shell 21, an illuminator 22 and a electric circuit 23 matching for the illuminator 22, therein said illuminator 22 can emit light messages, like “Go” or “Stop” literal messages and so on, due to said front braking indicator light 2 set upon the panoramic windshield 14, when cutting in power, said illuminator 22 can give out light ray in a certain intensity and a wide sight angle so that the people and vehicles in the front of the vehicle 1 can see it and know the tending action of the vehicle 1 through it to look out.

Although above-mentioned front braking indicator light 2 has certain reminding effect, but after further studying the principle of said front braking indicator light 2's structure, we can find that the front braking indicator light 2 has both indicating literal message and vehicle's relative message functions, so it is not to co-act with the original braking indicator light 13 synchronously, so that the effect is greatly discounted, in addition, the situation on the road is changed so fast that the driver can not give a correct judgment and action in some critical situation, and the quantity of vehicles on the road is gone up rapidly, so in this case, due to a little bit of carelessness, an accident may be occurred.

Additionally, said literal messages like “Go”, “Stop” and so on gave out from the illuminator 22 is supposed to remind people and vehicles in front the vehicle 1's running state, but even as the car runs in high-speed, the literal messages could not let the drivers and pedestrians in opposite know the meaning clearly and actually, so that the drivers on the opposite vehicles are not able to get the meaning of the lighted literal message and give a correct judgment based on the message, and take a correct action in a very short time, hence misjudgment is easy to be occurred to cause accident happened. Therefore, there is still a great space for innovating.

### SUMMARY OF THE INVENTION

It is therefore a main object of the present invention to provide a front braking indicator light, which can clearly indicate the running state to the vehicles and pedestrians in front for reminding them to avoid accident happened.

For achieving said main object, the present invention provides a front braking indicator light, which is mounted on a proper position of the front portion of the vehicle, and includes a base, a illuminator fitting on the base and a transparent shade covering on the base, wherein, said illuminator is connected to the control unit so that it can be lighted synchronously with the original braking indicator light as the driver is braking to slow down. The both braking indicator lights is lighted at the same time, not only indicating the running state of the vehicle, but also reminding the vehicles and pedestrians on the road to pay attention so as to avoid both sides misjudging to occur accident.

### BRIEF DESCRIPTION OF THE DRAWINGS

The accompanying drawing is to provide a further understanding of the invention and to incorporate in and constitute a part of this specification. The drawing illustrates an embodiment of the invention, and together with the description, serves to explain the principles of the invention. In the drawing,

FIG. 1 is a schematic view illustrating the braking indicator lights mounted on the car of the prior art.

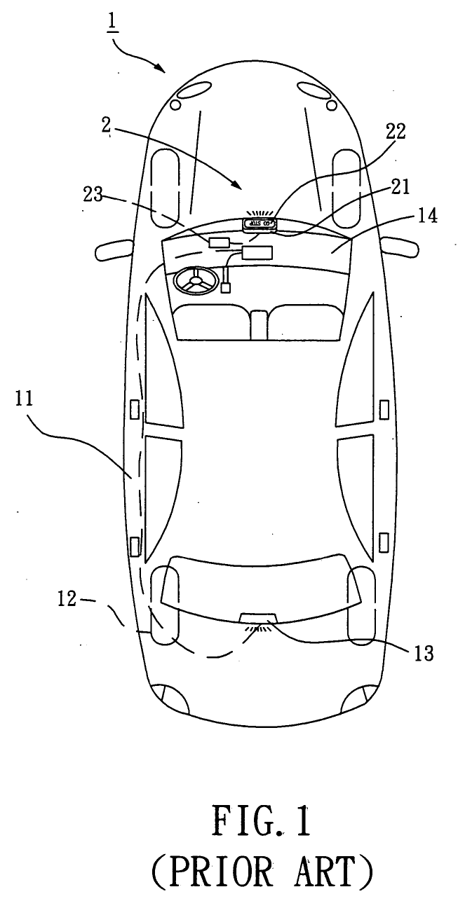

FIG. 2 is a schematic view illustrating a conventional braking indicator light of the prior art.

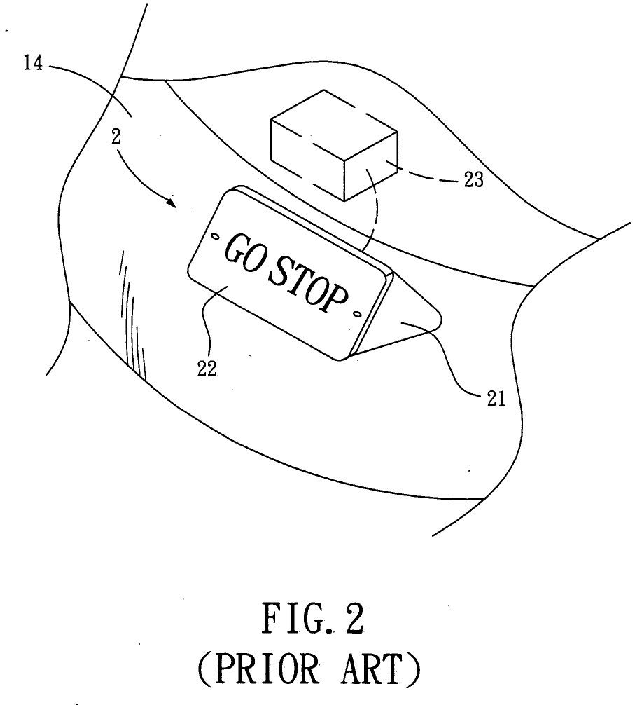

FIG. 3 is schematic view illustrating the braking indicator lights mounted on the car of the present invention.

FIG. 4 is a part schematic view illustrating the front braking indicator light mounted on the front of the car behind the windshield of the present invention.

FIG. 5 is a schematic view illustrating the front braking indicator light mounted on a motorcycle of the present invention.

### DETAILED DESCRIPTION OF THE PREFERRED EMBODIMENTS

Before describing the preferred embodiments of the present invention, note that similar components mentioned in following are given a same symbol number.

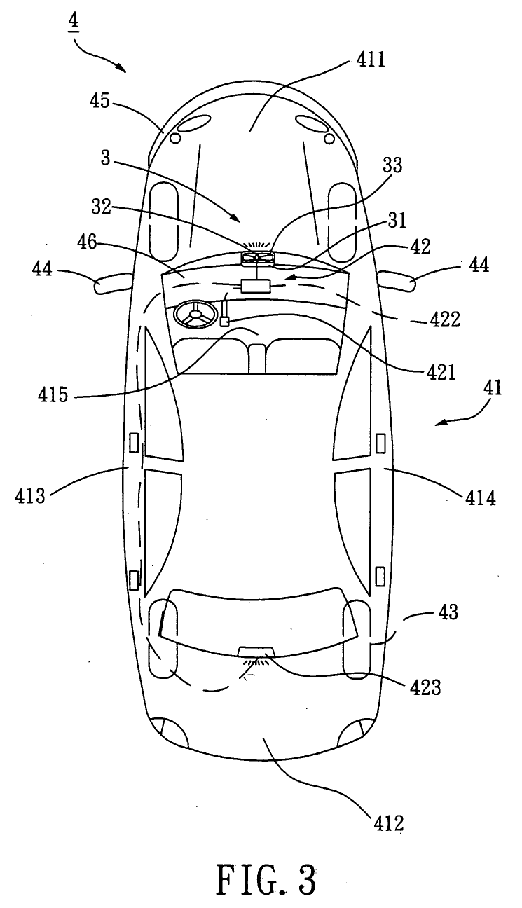

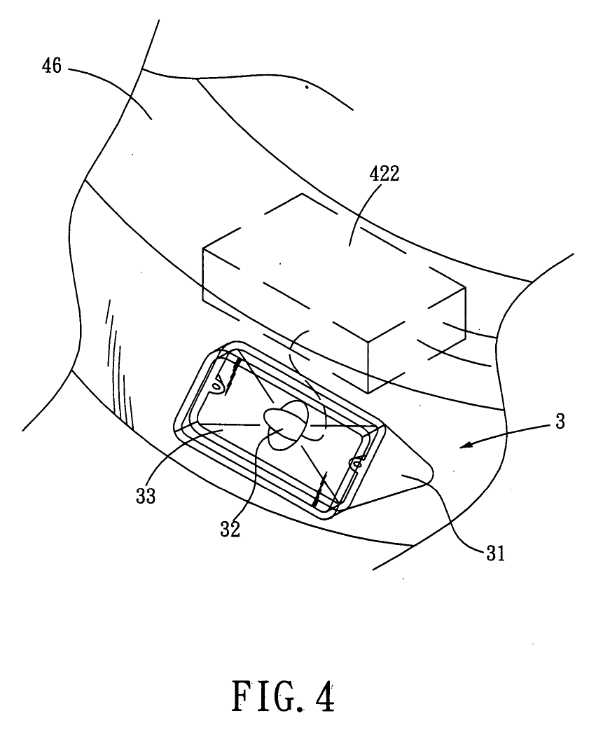

Referring to FIG. 3 and FIG. 4, the present invention provides a braking indicator light 3 of the vehicle 4 that is taken a car as an example in this embodiment. Said vehicle 4 has a body 41, a braking control unit 42 set upon the body 41 to connect with a front braking indicator light 3, and a set of wheels 43 carrying the body 41 to move; wherein said body 41 has a hood 411, a trunk lid 412, a left door side 413 and a right door side 414, all these shells surround a seating space, meanwhile a couple of wing mirrors 44 are set upon the two sides and extended out backward, and a front fender 45 built upon the front side extended out for protecting the head of nose.

On the other hand, said braking control unit 42 includes a brake 421 slowing down the wheels 43, a control unit 422 co-acting with the brake 421 synchronously, and a braking indicator light 423 connected with the control unit 422; and said front braking indicator light 3 is comprised of a base 31 mounted on the hood 411, an illuminator 32 held on the base 31, and a transparent shade 33 covering on the base 31, wherein, in this embodiment the base 31 is set upon behind the windshield 46, of course, it also can be set upon the back side of the inside rear-view mirror, or on the hood 411 above the front fender 45, said positions are drew out in drawings, meanwhile the illuminator 32 is connected with the control unit 422 so that it can be lighted with the braking indicator light 423 synchronously as stepping on the brake 421.

Referring to FIG. 3, during running, as over-passing the front vehicle or turning, the driver just needs to following actual situation to step on the brake 421, besides slowing down the car, the both braking indicator lights 32 423 are simultaneously lighted to remind all the vehicles and pedestrians on the road around the car that the car is braking, meanwhile the driver of the car can look at back side vehicles via the rear-view mirror to judge whether over-passing or turning, thereby avoid both side vehicles rushing into one way to occur accident; to the pedestrians crossing the street, the front braking indicator light can remind them the car is coming so that the safety of the drivers and pedestrians is improved, the rate of the accident happening is reduced in actual.

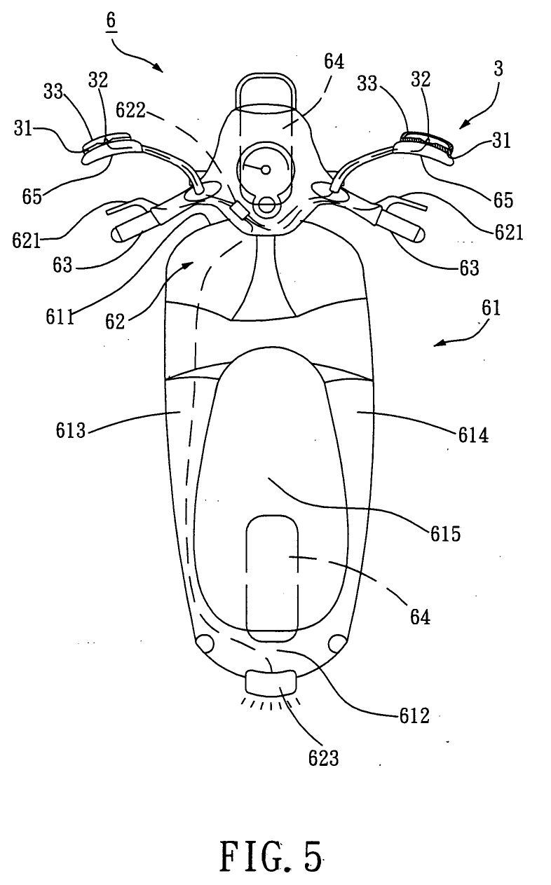

Referring to FIG. 5, the front braking indicator light 3 is mounted on a vehicle 6 in the second embodiment to remind the front vehicles and the pedestrians actively, in order to guard against accident happening and guarantee the people's safety. In this embodiment, said front braking indicator light 3 is mounted on a motorcycle 6, in which the vehicle 6 has a body 61, a braking control unit 62, a handlebar 63 steering running way of the vehicle 61, and a set of wheels 64 bringing the body 61 to move, wherein, the body 61 includes a head face 611, a tail 612, a left side 613 and a right side 614, a seat 615 set upon the middle top side of the body 611, and a rear-view mirror 65 extended out from the handlebar.

Additionally, said braking control unit 62 includes a brake 621 slowing the body 61 down, a control unit 622 synchronously acting with the brake 621, and a braking indicator light 623; whatever the difference in the structures of variety of motor cycles, the front braking indicator light 3 is fastened on the back side of the rear-view mirror 65 with the base 31 forward, on which an illuminator 32 is set and a transparent shade 33 is covered, meanwhile said illuminator 32 is connected to the control unit 624, so that when the brake 621 is pressed down, the braking indicator light 623 and said illuminator 32 is lighted synchronously.

Referring to FIG. 5, during running, if wanting to over-passing the front vehicles or turning, the driver just needs to press down the brake 621, not only to slow down the speed of the wheels 64, but also to light the braking indicator light 623 and the illuminator 32 in the same time to show the running state of the vehicle 6 to the ambient vehicle and the front pedestrians, in the same time, especially to the drivers of the vehicle 6 running in the front, he can know the state of the vehicle 6 running in the back via the rear-view mirror 65 so as to make a judgment whether continue the action of over-passing or turning, in this way, rushing into one way of the both vehicles 6 to occur accident can be efficiently avoided; to the pedestrians crossing the street, the active indicating effect of the front braking indicator light can remind them, in order to guarantee their safety from accident.

To sum up, the front braking indicator light of the present invention is to utilize synchronously lighting the front and the rear braking indicator lights by triggering the control unit as pressing down the brake, to actively remind the front vehicles and pedestrians so as to avoid the both sides misjudging to occur accident, meanwhile efficiently reduce the rate of accidents.

A front braking indicator light mounted on a vehicle, which includes a body, a braking control unit, wherein a handlebar steering running way of the vehicle, and a set of wheels bringing the body to move, in which, the body includes a head face, a tail, a left side and a right side, a seat set upon the top of the middle portion, and the braking control unit includes a brake slowing the body down, a control unit synchronously acting with the brake, and a braking indicator light, wherein, said front braking indicator light is comprised of a base mounted on the hood, an illuminator held on the base, and a transparent shade covering on the base, in which said illuminator is connected to the control unit, so that when the brake is pressed down, the braking indicator light and said illuminator is lighted synchronously to indicate the state of the vehicle to the front vehicles and pedestrians crossing the street for avoiding accident happening.

While the present invention has been described in connection with what is considered the most practical and preferred embodiments. It is understood that this invention is not limited to the disclosed embodiments but is intended to cover various arrangements included within the spirit and scope of the broadest interpretations and equivalent arrangements.

1. A front braking indicator light mounted on a vehicle, which includes a body, a braking control unit set upon the body to connect with a front braking indicator light, and a set of wheels carrying the body to move; wherein said body has a hood, a trunk lid, a left door side and a right door side, all these shells surround a seating space, and said braking control unit includes a brake slowing down the wheels, a control unit co-acting with the brake synchronously, wherein, said front braking indicator light is comprised of a base mounted on the hood, an illuminator held on the base, and a transparent shade covering on the base, in which said illuminator is connected to the control unit, so that when the brake is pressed down, the braking indicator light and said illuminator is lighted synchronously to indicate the state of the vehicle to the front vehicles and pedestrians crossing the street for avoiding accident happening.

2. A front braking indicator light as claimed in claim 1, wherein said vehicle extends out a rear-view mirror, and the back side of the rear-view mirror is used to locate the base of the front braking indicator light.

3. A front braking indicator light as claimed in claim 1, wherein said vehicle extends out a front fender around the head rim, and the front braking indicator light is located above the front fender.

4. A front braking indicator light mounted on a vehicle, which includes a body, a braking control unit, wherein a handlebar steering running way of the vehicle, and a set of wheels bringing the body to move, in which, the body includes a head face, a tail, a left side and a right side, a seat set upon the top of the middle portion, and the braking control unit includes a brake slowing the body down, a control unit synchronously acting with the brake, and a braking indicator light, wherein, said front braking indicator light is comprised of a base mounted on the hood, an illuminator held on the base, and a transparent shade covering on the base, in which said illuminator is connected to the control unit, so that when the brake is pressed down, the braking indicator light and said illuminator is lighted synchronously to indicate the state of the vehicle to the front vehicles and pedestrians crossing the street for avoiding accident happening.
